(19) United States
(12) Patent Application Publication
(10) Pub. No.: US 2026/0121215 A1
(43) Pub. Date: Apr. 30, 2026

(54) BATTERY PACK

(71) Applicant: EVE POWER CO.,LTD., JINGMEN (CN)

(72) Inventor: WEICAI HUANG, JINGMEN (CN)

(21) Appl. No.: 19/004,461

(22) Filed: Dec. 30, 2024

Related U.S. Application Data
(63) Continuation of application No. PCT/CN2022/144223, filed on Dec. 30, 2022.

(30) Foreign Application Priority Data
Dec. 14, 2022 (CN) 202211598515.7

(51) Int. Cl. H01M 50/367; H01M 10/658; H01M 50/213; H01M 50/244; H01M 50/262; H01M 50/289; H01M 50/383

(52) U.S. Cl. CPC H01M 50/367; H01M 10/658; H01M 50/213; H01M 50/244; H01M 50/262; H01M 50/289; H01M 50/383

(57) ABSTRACT

A battery pack includes a box and a battery module arranged in the box. The battery module includes a pair of battery assemblies and a module bracket. Each battery assembly includes a support tray and a plurality of cells. The support tray is penetrated with through holes for arranging. pressure relief valves of the cells. The pressure relief valves of the cells of the pair of battery assemblies are arranged facing each other. The support tray is provided with pressure relief holes. The module bracket is arranged between a pair of the support trays and provided with first pressure relief channels. A pressure relief cavity is provided between the pair of support trays. The box is provided with third pressure relief channels. The through holes, the pressure relief cavity, the first pressure relief channels, the third pressure relief channels, and the pressure relief holes are in communication.

### CROSS-REFERENCE TO RELATED APPLICATION(S)

The present disclosure is a continuation application of International application No. PCT/CN2022/144223, filed on Dec. 30, 2022, which claims priority to Chinese Patent Application No. 202211598515.7, filed on Dec. 14, 2022, the disclosure of which are incorporated herein by reference in their entireties.

### TECHNICAL FIELD

The present disclosure relates to the technical field of battery packs, and in particular, to a battery pack.

### BACKGROUND

In recent years, the demand for lightweight vehicles has been increasing. Especially in the field of new energy vehicles, the endurance range has always been a bottleneck restricting performance development. In related technologies, improving the endurance range usually starts from the perspective of increasing the total energy of the battery, which usually includes increasing the energy density of the battery pack or increasing the number of modules. In order to improve the space utilization of electric vehicles, a double-layer module is usually arranged. The arrangement of the double-layer module can effectively utilize the envelope space and improve the endurance range of electric vehicles.

In the design process of double-layer module battery packs in related technologies, it is usually difficult to design a special exhaust and pressure relief channel due to difficulty in sealing. Due to the lack of special exhaust and pressure relief channels in the battery pack with a double-layer module, when the cells in the module experience thermal runaway, a large amount of gas accompanied by flames is instantly released from the cells. Due to the lack of directional exhaust channels to guide away these gases and flames, they will randomly spread inside the battery pack, which can easily ignite other components and cause thermal runaway in other normally used cells, causing the thermal runaway to spread and easily lead to fire or explosion, thus, there is room for improvement.

### SUMMARY

The present disclosure provides a battery pack to prevent thermal runaway from spreading.

The battery pack includes a battery module and a box. The battery module includes a pair of battery assemblies stacked along a height direction of the battery pack and a module bracket. Each of the battery assemblies includes a support tray and a plurality of cell. The support tray is penetrated with a plurality of through holes along its height direction, and pressure relief valves of the plurality of single cells are arranged at the plurality of through holes in a one-to-one correspondence manner. The pressure relief valves of the cells of the pair of battery assemblies arranged along the height direction are arranged facing each other. The support tray is further provided with a plurality of pressure relief holes. The module bracket is arranged between a pair of the support trays of the pair of battery assemblies arranged along the height direction. The module bracket is provided with a plurality of first pressure relief channels. A pressure relief cavity is arranged between the pair of the support trays arranged along the height direction. The through holes, the pressure relief cavity, the first pressure relief channels and the pressure relief holes are in communication. The battery module is arranged in the box, and the box is provided with a third pressure relief channel. The third pressure relief channel is in communication with the pressure relief holes.

### BRIEF DESCRIPTION OF THE DRAWINGS

FIG. 1 is a schematic structural diagram of a battery pack in embodiments of the present disclosure;

FIG. 2 is a schematic diagram of the internal structure of a battery pack in embodiments of the present disclosure;

FIG. 3 is a partial enlarged view of an area A in FIG. 2;

FIG. 4 is another schematic diagram of the internal structure of a battery pack in embodiments of the present disclosure;

FIG. 5 is a schematic structural diagram of a support tray in embodiments of the present disclosure;

FIG. 6 is a schematic structural diagram of a module bracket in embodiments of the present disclosure;

FIG. 7 is a schematic diagram of a disassembled state of a battery module in embodiments of the present disclosure;

Reference numerals in the drawings: 100, battery pack; 10, battery module; 1, battery assembly; 11, support tray; 111, through hole; 112, pressure relief hole; 113, tray body; 114, tray extension member; 12, cell; 2, module bracket; 21, first pressure relief channel; 3, pressure relief cavity; 4, first cross beam; 41, second pressure relief channel; 5, fireproof board; 6, box; 7, side beam; 71, third pressure relief channel; 72, explosion-proof valve; 8, locking member.

### DETAILED DESCRIPTION

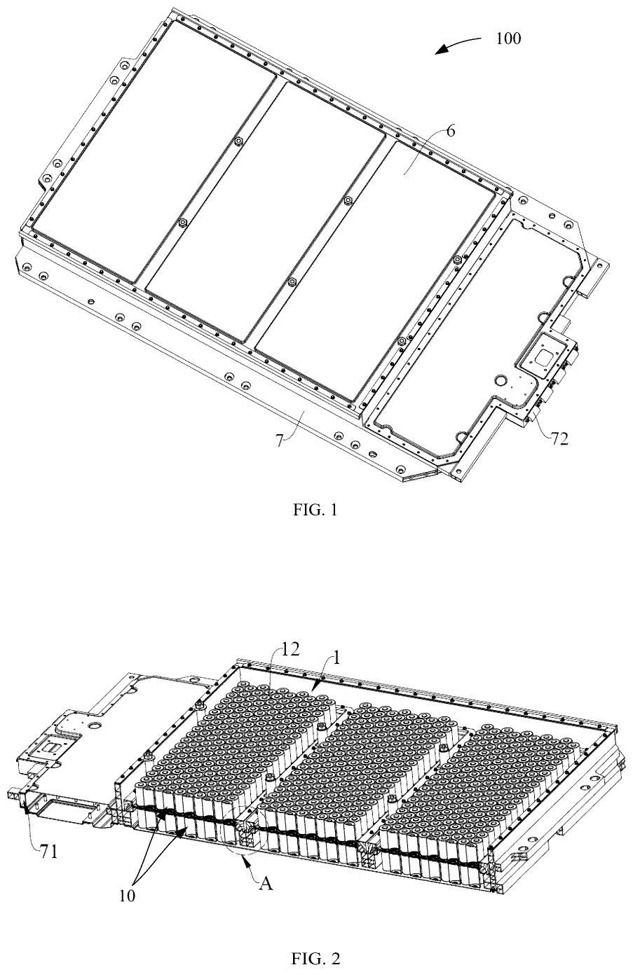

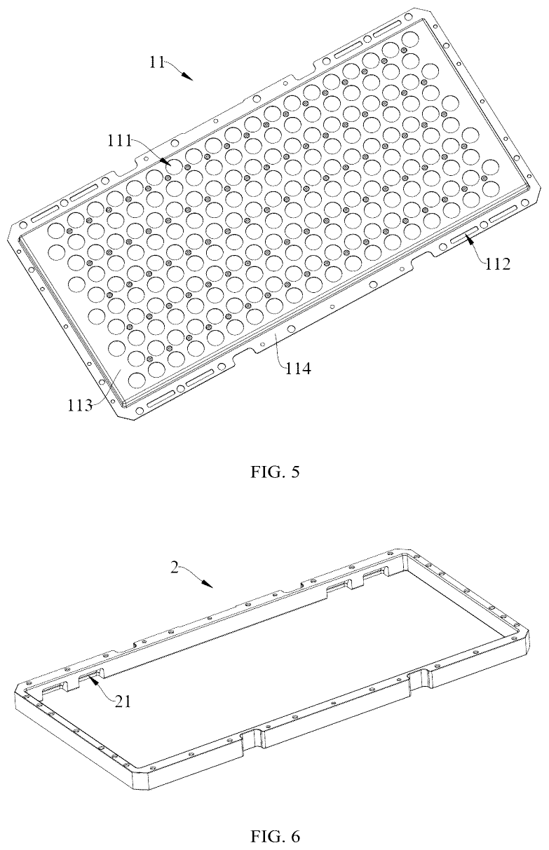

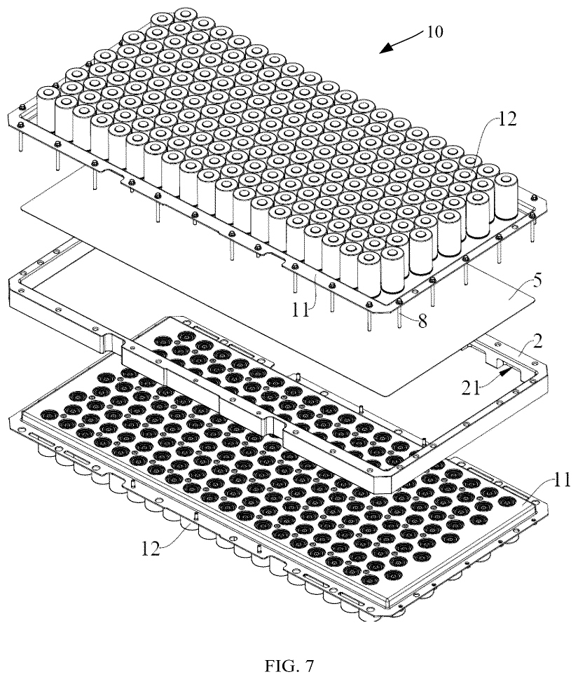

A battery pack and an electrical device according to the embodiments of the present disclosure will be described below with reference to FIGS. 1 to 6. Some embodiments of the present disclosure will be described in detail below with reference to the accompanying drawings. In the absence of conflict, the following embodiments and features in the embodiments may be combined with each other.

In recent years, the demand for lightweight vehicles has been increasing. Especially in the field of new energy vehicles, the endurance range has always been a bottleneck restricting performance development. In related technologies, improving the endurance range usually starts from the perspective of increasing the total energy of the battery, which usually includes increasing the energy density of the battery pack or increasing the number of modules. In order to improve the space utilization of electric vehicles, a double-layer module is usually arranged. The arrangement of the double-layer module can effectively utilize the envelope space and improve the endurance range of electric vehicles.

In the design process of battery packs with double-layer modules in related technologies, it is usually difficult to design special exhaust and pressure relief channels due to difficulty in sealing. When the cells in the module experience thermal runaway, a large amount of gas accompanied by flames is instantly released from the cells. Due to the lack of special exhaust and pressure relief channels in the battery pack with a double-layer module to guide away these gases and flames, these gases and flames will randomly spread inside the battery pack, which can easily ignite other components and cause thermal runaway in other normally used cells, causing the thermal runaway to spread and easily lead to fire or explosion, thus, there is room for improvement.

In view of this, the battery pack in the embodiments of the present disclosure is designed with special exhaust and pressure relief structures for the double-layer module, so as to guide away these gases and flames in a directed manner when thermal runaway occurs to prevent the spread of thermal runaway.

Specifically, please refer to FIGS. 1 to 6, the battery pack 100 in the embodiments of the present disclosure includes a battery module 10, a module bracket 2 and a box 6.

In some embodiments, the battery module 10 includes a pair of battery assemblies 1 stacked up and down along a height direction of the battery pack 100 and a module bracket 2. Each battery assembly 1 includes a support tray 11 and a plurality of cells 12. The support tray 11 is penetrated with a plurality of through holes 111 along its own height direction. The pressure relief valves of the plurality of cells 12 are arranged at the plurality of through holes 111 in a one-to-one correspondence manner, and the pressure relief valves of the cells 12 of the pair of battery assemblies 1 arranged along the height direction are arranged facing each other. The support tray 11 is further provided with a plurality of pressure relief holes 112. The module bracket 2 is arranged between a pair of support trays 11 of the pair of battery assemblies 1 arranged along the height direction, and the module bracket 2 is provided with a plurality of first pressure relief channels 21. A pressure relief cavity 3 is provided between a pair of support trays 11 of the pair of battery assemblies 1 arranged along the height direction. The through holes 111, the pressure relief cavity 3, the first pressure relief channels 21 and the pressure relief holes 112 are in communication. The battery module 10 is arranged in the box 6. The box 6 is provided with third pressure relief channels 71, and the third pressure relief channels 71 are in communication with the pressure relief holes 112.

In actual applications, in the double-layer battery assemblies 1 in the battery pack 100 of the embodiments of the present disclosure, the cells in the battery assemblies 1 are cylindrical cells. Since the explosion-proof valve of the cylindrical cell is arranged at a bottom of the cell itself, the double-layer battery assemblies 1 adopt an installation structure in which the bottoms of the cells are arranged facing each other. When the cell experiences thermal runaway, the gas and flame generated will be concentrated through a corresponding through hole 111 in the pressure relief cavity 3 formed between the pair of the support trays 11 arranged along the height direction, and then the gas and flame generated will flow to the first pressure relief channel 21 of the module bracket 2, and then flow to the pressure relief hole 112 of the support tray 11, and finally flow into the third pressure relief channel 71 of the box 6. These gases and flames are guided away through the third pressure relief channel 71, effectively preventing the gas and flame from spreading randomly inside the battery pack 100, effectively preventing the spread of thermal runaway, and preventing more serious fires or explosions.

It was found in further applications that the arrangement of a double-layer module in the battery pack can effectively improve the endurance range of electric vehicles, but it will increase the thickness of the battery pack. Therefore, in order to reduce the overall thickness of the battery pack, in the embodiments of the present disclosure, the structure of the support tray 11 is improved, and the installation position of the module bracket 2 is also adjusted accordingly, which reduces the thickness of the battery pack to a certain extent and achieves miniaturization and portability.

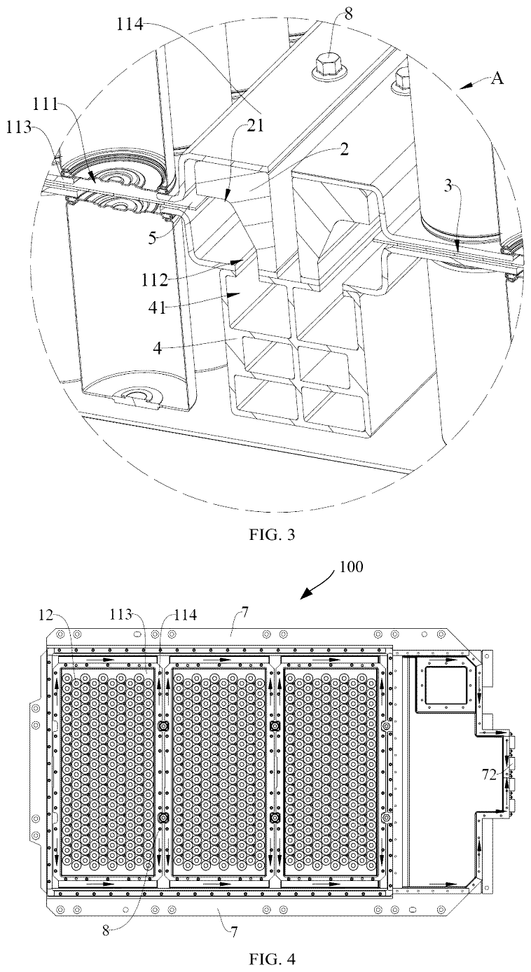

Specifically, please refer to FIGS. 1 to 6, in the battery pack 100 of the embodiments of the present disclosure, each support tray 11 includes a tray body 113 formed with a mounting groove and a tray extension member 114 arranged at circumferential edges of the tray body 113. Each tray body 113 is provided with the plurality of through holes 111 running through its own height direction. The bottom of the mounting groove of the tray body 113 is spaced a predetermined distance from the tray extension member 114. The pressure relief cavity 3 is formed between a pair of tray bodies 113 arranged along the height direction, and the module bracket 2 is arranged between a pair of tray extension members 114 arranged along the height direction. In some embodiments, as shown in FIG. 3, a pair of the support trays 11 of the pair of battery assemblies 1 arranged along the height direction are symmetrically arranged, and the tray extension member 114 of the support tray 11 located at a lower side is provided with the plurality of the pressure relief holes 112.

In actual applications, the battery module 10 of the battery pack 100 in the embodiments of the present disclosure is provided with a pair of support trays 11. Due to the tray body 113 with the mounting groove being formed on the support tray 11, and the bottom of the mounting groove of the tray body 113 being spaced a predetermined distance from the tray extension members 114, so that an installation gap is formed between the pair of tray extension members 114 of the support tray 11 arranged along the height direction for installing the module bracket 2. Therefore, the cells 12 are correspondingly installed in the mounting groove of the tray body 113, the module bracket 2 is correspondingly arranged between a pair of the tray extension members 114 arranged along the height direction, and the cells 12 are surrounded inside the module bracket 2, so that the cells 12 and the module bracket 2 partially overlap in height, making the structure more compact, reducing the thickness of the battery pack 100 to a certain extent, and achieving miniaturization and portability of the battery pack 100.

It can be understood that when the battery experiences thermal runaway, the gas and flame generated will be concentrated in the pressure relief cavity 3, and then the gas and flame generated will flow toward edges of the support tray 11, then flow to the first pressure relief channel 21 of the module bracket 2, and then flow to the pressure relief hole 112 of the support tray 11, and finally flow into the third pressure relief channel 71 of the box 6. These gases and flames are guided away through the third pressure relief channel 71, effectively preventing the gas and flame from spreading randomly inside the battery pack 100, effectively preventing the spread of thermal runaway, and preventing more serious fires or explosions.

Existing battery packs are usually made into a square shell shape. In order to adapt to the square shell shape, in the battery pack 100 of the embodiments of the present disclosure, the tray extension member 114 and the module bracket 2 are both in a rectangular ring shape.

Of course, in some other embodiments, the tray extension member 114 and the module bracket 2 may be in a circular shape.

It was found in further applications that due to the double-layer module configuration is employed in the battery pack, when one layer of cells 12 experience thermal runaway, the gas and flame generated will spray toward bottoms of the cells in an opposite layer of cells 12, thereby causing thermal runaway in the opposite layer of cells 12. Therefore, in order to prevent thermal runaway caused by the gas and flame generated spraying to the bottoms of the opposite layer of cells 12, the battery pack 100 arranges a fireproof board 5 in the double-layer module, to prevent the thermal runaway from spreading between the double-layer module.

Specifically, please refer to FIGS. 1 to 6, in the battery pack 100 in the embodiments of the present disclosure, the battery module 10 further includes a fireproof board 5. The fireproof board 5 is arranged between a pair of tray bodies 113 of the pair of battery assemblies 1 arranged along the height direction. The through holes 111 of the tray body 113 located at an upper layer and the through holes 111 of the tray body 113 located at a lower layer are separated by the fireproof board 5.

In actual applications, when thermal runaway occurs in one layer of cells 12 of the battery pack 100 in the embodiments of the present application, the gas and flame generated will spray toward the fireproof board 5, flow along the fireproof board 5 toward the edges of the support tray 11, then flow to the first pressure relief channel 21 of the module bracket 2, and then flow into the pressure relief hole 112 of the support tray 11, and finally flow into the third pressure relief channel 71 of the box 6. These gases and flames are guided away through the third pressure relief channel 71, effectively preventing the gases and flames from spreading randomly inside the battery pack 100, effectively preventing the spread of thermal runaway, and preventing more serious fires or explosions. In addition, it also effectively prevents thermal runaway caused by the gas and flame generated spraying to the bottoms of the opposite layer of cells 12, and prevents the thermal runaway from spreading between the double-layer module.

The fireproof board 5 may be a mica board, for example, a high-temperature resistant mica board, which may be formed by bonding, heating and pressing mica paper and organic silicone glue, where the mica content is about 90% and the organic silicone glue content is 10%.

It was found in further applications that in order to increase the battery capacity of the battery pack, a plurality of battery modules are usually arranged in the battery pack. In order to enable the plurality of battery modules to reasonably discharge the gas and flame generated when thermal runaway occurs, the battery pack 100 improves the structure of the box 6.

Specifically, please refer to FIGS. 1 to 6, in the battery pack 100 in the embodiments of the present disclosure, the battery pack 100 includes a plurality of the battery modules 10, and the box 6 is provided with side beams 7 and a plurality of first cross beams 4. The side beams 7 are enclosed to form a frame structure. The side beams 7 are provided with the third pressure relief channels 71. The plurality of first cross beams 4 are arranged inside the frame structure and connected to the side beams 7. The plurality of first cross beams 4 separate a plurality of areas within the frame structure, and each of the areas is provided with one of the battery modules 10.

In other embodiments, the first cross beam 4 is provided with a second pressure relief channel 41. The first pressure relief channel 21, the pressure relief hole 112, the second pressure relief channel 41 and the third pressure relief channel 71 are in communication.

In actual applications, the plurality of battery modules 10 and the plurality of first cross beams 4 of the battery pack 100 in the embodiments of the present disclosure are arranged at staggered intervals, so that each battery module 10 is arranged between two first cross beams 4. When the battery experiences thermal runaway, the gas and flame generated will be concentrated through the through holes 111 in the pressure relief cavity 3 formed between a pair of the support trays 11 arranged along the height direction, and then the gas and flame generated will flow to the first pressure relief channel 21 of the module bracket 2, and then flow to the pressure relief hole 112 of the support tray 11, then flow into the second pressure relief channel 41 of the first cross beam 4, and finally flow into the third pressure relief channel 71 of the box 6. These gases and flames are guided away through the third pressure relief channel 71, effectively preventing the gas and flame from spreading randomly inside the battery pack 100, effectively preventing the spread of thermal runaway, and preventing more serious fires or explosions.

Moreover, from a positional point of view, as shown in FIG. 4, the gas and flame generated by the battery module 10 will flow to the first cross beams 4 on both sides of the battery module 10, and then be guided away through the second pressure relief channel 41, effectively preventing the gas and flame from spreading randomly inside the battery pack 100, and effectively preventing the spread of thermal runaway, so as to prevent more serious fires or explosions.

A flow guide structure of the gas and flame generated can be specifically referred to FIGS. 1 to 6. The side beam 7 is provided with an exhaust hole, which is in communication with the outside of the box 6 and the third pressure relief channel 71. The exhaust hole is blocked with an explosion-proof valve 72, and the explosion-proof valve 72 is in communication with the third pressure relief channel 71. The side beam 7 may be specifically in a concave shape.

In actual applications, when thermal runaway occurs in the battery module 10, the gas and flame generated will flow to the second pressure relief channel 41 in the first cross beam 4, and then flow to the third pressure relief channel 71 of the side beam 7, and finally flow to the explosion-proof valve 72 to automatically open the explosion-proof valve 72 to release pressure, so as to prevent the battery pack 100 from exploding.

It was found in further applications that since the fireproof board 5 is arranged between a pair of tray bodies 113 arranged along the height direction, the gas and flame generated would spray toward the fireproof board 5 when thermal runaway occurs. Therefore, the fireproof board 5 needs to be fixed to prevent it from deflecting caused by being sprayed during thermal runaway. The battery pack 100 clamps the fireproof board 5 through a clamping structure to fix the fireproof board 5.

Specifically, please refer to FIGS. 1 to 6, in the battery pack in the embodiments of the present disclosure, the module bracket 2 and a pair of tray extension members 114 arranged along the height direction are connected by locking members 8 to clamp the fireproof board 5.

In actual application, the battery pack 100 locks a pair of tray extension members 114 to the module bracket 2 through the locking members 8, and then clamps the fireproof board 5 through the pair of tray bodies 113 to achieve the fixation of the fireproof board 5 and prevent it from being deflecting caused by sprayed during thermal runaway. The locking member 8 may be specifically a bolt or a screw.

The embodiments of the present disclosure disclose not only a battery pack, but also an electrical device including the battery pack. The electrical device may be, but is not limited to, a mobile phone, a tablet, a laptop, an electric toy, an electric tool, an electric vehicle, an electric car, a ship, a spacecraft, etc. The electric toy may include a fixed or mobile electric toy, such as a game console, an electric car toy, an electric ship toy and an electric airplane toy, etc. The spacecraft may include an airplane, a rocket, a space shuttle and a spaceship, etc. The power tool includes a metal-cutting power tool, a grinding power tool, an assembly power tool and a railway power tool, such as an electric drill, an electric grinder, an electric wrench, an electric screwdriver, an electric hammer, an impact drill, a concrete vibrator and an electric planer.

What is claimed is:

1. A battery pack (100), comprising:
a battery module (10) comprising:
a pair of battery assemblies (1) stacked along a height direction of the battery pack (100); wherein each of the battery assemblies (1) comprises a support tray (11) and a plurality of cells (12); wherein the support tray (11) is penetrated with a plurality of through holes (111) along its own height direction; pressure relief valves of the plurality of cells (12) are arranged at the plurality of through holes (111) in a one-to-one correspondence manner, and the pressure relief valves of the cells (12) of the pair of battery assemblies (1) arranged along the height direction are arranged facing each other; the support tray (11) is further provided with a plurality of pressure relief holes (112); and
a module bracket (2) arranged between a pair of the support trays (11) of the pair of battery assemblies (1) arranged along the height direction; wherein the module bracket (2) is provided with a plurality of first pressure relief channels (21); wherein a pressure relief cavity (3) is provided between the pair of the support trays (11) arranged along the height direction; wherein the through holes (111), the pressure relief cavity (3), the first pressure relief channels (21) and the pressure relief holes (112) are in communication; and
a box (6), wherein the battery module (10) is arranged in the box (6); the box (6) is provided with third pressure relief channels (71); wherein the third pressure relief channels (71) are in communication with the pressure relief holes (112).

2. The battery pack (100) according to claim 1, wherein the support tray (11) comprises a tray body (113) formed with a mounting groove and a tray extension member (114) arranged at circumferential edges of the tray body (113); wherein the tray body (113) is provided with the plurality of through holes (111) running through its own height direction;
the pressure relief cavity (3) is formed between a pair of tray bodies (113) arranged along the height direction, and the module bracket (2) is arranged between a pair of tray extension members (114) arranged along the height direction.

3. The battery pack (100) according to claim 2, wherein the tray extension member (114) and the module bracket (2) are both in a rectangular ring shape.

4. The battery pack (100) according to claim 2, wherein the battery module (10) further comprises a fireproof board (5) arranged between a pair of the tray bodies (113) of the pair of battery assemblies (1) arranged along the height direction; wherein the through holes (111) of the tray body (113) located at an upper layer and the through holes (111) of the lower tray body (113) located at a lower layer are separated by the fireproof board (5).

5. The battery pack (100) according to claim 4, wherein the fireproof board (5) is a mica board.

6. The battery pack (100) according to claim 2, wherein a bottom of the mounting groove of the tray body (113) is spaced a predetermined distance from the tray extension members (114).

7. The battery pack (100) according to claim 2, wherein the battery pack (100) comprises a plurality of the battery modules (10); the box (6) is provided with side beams (7) and a plurality of first cross beams (4); wherein the side beams (7) are enclosed to form a frame structure; the side beams (7) are provided with the third pressure relief channels (71);
the plurality of the first cross beams (4) are arranged inside the frame structure and connected to the side beams (7); the plurality of the first cross beams (4) separate a plurality of areas within the frame structure, and each of the areas is provided with one of the battery modules (10).

8. The battery pack (100) according to claim 3, wherein the battery pack (100) comprises a plurality of the battery modules (10); the box (6) is provided with side beams (7) and a plurality of first cross beams (4); wherein the side beams (7) are enclosed to form a frame structure; the side beams (7) are provided with the third pressure relief channels (71);
the plurality of the first cross beams (4) are arranged inside the frame structure and connected to the side beams (7); the plurality of the first cross beams (4) separate a plurality of areas within the frame structure, and each of the areas is provided with one of the battery modules (10).

9. The battery pack (100) according to claim 4, wherein the battery pack (100) comprises a plurality of the battery modules (10); the box (6) is provided with side beams (7) and a plurality of first cross beams (4); wherein the side beams (7) are enclosed to form a frame structure; the side beams (7) are provided with the third pressure relief channels (71);
the plurality of the first cross beams (4) are arranged inside the frame structure and connected to the side beams (7); the plurality of the first cross beams (4) separate a plurality of areas within the frame structure, and each of the areas is provided with one of the battery modules (10).

10. The battery pack (100) according to claim 6, wherein the first cross beam (4) is provided with a second pressure relief channel (41); wherein the first pressure relief channel (21), the pressure relief hole (112), the second pressure relief channel (41) and the third pressure relief channel (71) are in communication.

11. The battery pack (100) according to claim 7, wherein the first cross beam (4) is provided with a second pressure relief channel (41); wherein the first pressure relief channel (21), the pressure relief hole (112), the second pressure relief channel (41) and the third pressure relief channel (71) are in communication.

12. The battery pack (100) according to claim 8, wherein the first cross beam (4) is provided with a second pressure relief channel (41); wherein the first pressure relief channel (21), the pressure relief hole (112), the second pressure relief channel (41) and the third pressure relief channel (71) are in communication.

13. The battery pack (100) according to claim 9, wherein the first cross beam (4) is provided with a second pressure relief channel (41); wherein the first pressure relief channel (21), the pressure relief hole (112), the second pressure relief channel (41) and the third pressure relief channel (71) are in communication.

14. The battery pack (100) according to claim 10, wherein a pair of the support trays (11) of the pair of battery assemblies (1) arranged along the height direction are symmetrically arranged, and the tray extension member (114) of the support tray (11) located at a lower side is provided with the plurality of the pressure relief holes (112).

15. The battery pack (100) according to claim 6, wherein the side beam (7) is provided with an explosion-proof valve (72); wherein the explosion-proof valve (72) is communicated with the third pressure relief channel (71).

16. The battery pack (100) according to claim 7, wherein the side beam (7) is provided with an explosion-proof valve (72); wherein the explosion-proof valve (72) is communicated with the third pressure relief channel (71).

17. The battery pack (100) according to claim 8, wherein the side beam (7) is provided with an explosion-proof valve (72); wherein the explosion-proof valve (72) is communicated with the third pressure relief channel (71).

18. The battery pack (100) according to claim 9, wherein the side beam (7) is provided with an explosion-proof valve (72); wherein the explosion-proof valve (72) is communicated with the third pressure relief channel (71).

19. The battery pack (100) according to claim 4, wherein the module bracket (2) and a pair of tray extension members (114) arranged along the height direction are connected by locking members (8) to clamp the fireproof board (5).

20. The battery pack (100) according to claim 5, wherein the module bracket (2) and a pair of tray extension members (114) arranged along the height direction are connected by locking members (8) to clamp the fireproof board (5).
